(19) United States
(12) Patent Application Publication
(10) Pub. No.: US 2007/0272589 A1
(43) Pub. Date: Nov. 29, 2007

(54) Allowance Method for Point to Ground Resistance of Tray

(76) Inventors: Kwang Suck Suh, Kyungki-do (KR); Jong Eun Kim, Seoul (KR)

Correspondence Address: BACON & THOMAS, PLLC, 625 SLATERS LANE, FOURTH FLOOR, ALEXANDRIA, VA, 22314, US

(21) Appl. No.: 10/550,056

(22) PCT Filed: Mar. 22, 2004
(86) PCT No.: PCT/KR04/00627

§ 371 Date: Mar. 22, 2007

(30) Foreign Application Priority Data
Mar. 21, 2003 (KR) 10-2003-0017904

(51) Int. Cl. H01B 1/24

(52) U.S. Cl. 206/719; 156/47

(57) ABSTRACT

Disclosed is a method of providing a desired range of point-to-ground resistance to trays, by making a conductive pathway between both surfaces of the tray after forming and cutting processes. A desired range of point-to-ground resistance of the tray can be achieved by partially or entirely coating a conductive solution composed of a conductive polymersuch as polyaniline, polypyrrole, polythiophene and derivatives such as poly 3,4-ethylenedioxythiophene and mixtures thereof, metal powders and flakes composed of iron, copper, aluminum and other metals, metal oxides such as doped tin oxide and indium oxide, onto cut surfaces of the tray, by attaching a conductive or semi-conductive tape to top and bottom surfaces of the tray so as to cross them, or by using a metal clip. Thereby, a desired range of point-to-ground resistance can be provided to the tray by electrically connecting the top and bottom surfaces of the tray.

### TECHNICAL FIELD

The present invention relates to, in general, trays for use in storing and transporting electro-statically sensitive electronic parts, and particularly, a method of providing a desired range of point-to-ground resistance to trays, thereby strengthening the antistatic properties of the trays.

### BACKGROUND ART

Generally, electronic parts that are easily damaged by static electricity should be stored or transported in containers or packing using antistatic finishing. Therefore, antistatic products are increasingly made of a polymer sheet or a specific material, which is subjected to an antistatic.

However, upon the forming and cutting processes of the fabrication of antistatic products, some of antistatic properties of the material may be lost. In such cases, the resulting products loose their antistatic properties partially, and thus, electronic parts may be damaged by static electricity.

In particular, an untreated polymer material may cause damage from static that is generated by instantaneously discharging charges accumulated on the surface of the polymer material. Hence, when a proper antistatic agent is applied on the polymer material, the polymer material can exhibit antistatic properties. Accordingly, antistatic techniques using surface coating process have been widely used.

Moreover, fabrication of a tray with a compound composed of a pre-mixture of an antistatic component and the polymer material can effectively produce desirable antistatic properties, even if the antistatic component is used in small amounts. This is because the antistatic component present in the tray allows charges present on the tray surface to be discharged through the component in the tray and a grounded work table in contact with the tray. Further, since an antistatic component always remains in the tray, static charges are continuously discharged when in contact with the ground.

However, the antistatic technique of coating a polymer with an antistatic agent is disadvantageous in that an antistatic layer coated on any one surface of the polymer is not necessarily electrically connected with an antistatic layer of the other surface thereof. Therefore, since the tray has no point-to-ground resistance, the charge accumulated on the tray cannot be effectively discharged. Thereby, the charge continuously accumulates to any one portion of the tray, resulting in a loss of antistatic properties of the tray. Eventually, to efficiently transport high-value electronic parts sensitive to static electricity, for example, a head stack assembly (HSA) for a hard disk drive in a computer storage device, the tray for transporting the electronic parts should have the desired range of point-to-ground resistance.

In cases where the tray for transporting electronic parts is manufactured by use of a conductive sheet having antistatic properties through a surface coating process, the conductive sheet is subjected to either vacuum forming or compressive forming and then cutting, hence it is formed into the tray having four cut surfaces of predetermined sizes. However, the cut portions of the tray have insulation properties, and the top and bottom surfaces of the tray are not electrically connected to each other. Thus, when the antistatic layer of the top surface of the tray has excessive charges, it is discharged into a charge-containing layer. In addition, the accumulated charge of the top surface of the tray increase, thus the top surface thereof looses its antistatic properties. Therefore, a method of electrically connecting the top and bottom surfaces of the tray is required in order to effectively discharge the accumulated charge on the surface of the tray.

### DISCLOSURE OF THE INVENTION

Therefore, the object of the present invention is to alleviate the problems encountered in the related art, and to provide a method of providing a desired range of point-to-ground resistance to trays, by coating the polymer film with a conductive solution to prepare a conductive sheet having an antistatic layer thereon, cutting the conductive sheet to be formed into a tray, and by forming a conductive pathway on all, or parts, of the cut surfaces of the tray.

Another object of the present invention is to provide a tray having desired range of point-to-ground resistance using the above method.

### BRIEF DESCRIPTION OF THE DRAWINGS

The above, other objects, features, and other advantages of the present invention will be clearly understood from the following detailed description taken in conjunction with the accompanying drawings, in which:

FIG. 1 is a plan view of a tray using the present invention; and

FIG. 2 is a partially enlarged view of a cut surface of the tray before a conductive solution is applied.

### BEST MODE FOR CARRYING OUT THE INVENTION

Based on the present invention, a method of providing a desired range of point-to-ground resistance to trays is characterized in that a conductive solution is applied to a polymer film to form a conductive sheet having an antistatic layer thereon, the conductive sheet is then cut to be formed into a tray, and all, or parts, of the cut surfaces of the tray are formed with a conductive pathway.

In such cases, with the aim of forming the conductive pathway on the cut surfaces of the tray, one through four cut surfaces of the tray are electrically connected by a partial or entire a coat of a conductive solution, use of an antistatic polymer product, a metal clip or clamp, or are attached with a conductive tape.

The conductive solution of the present invention is applied to the conductive sheet having an antistatic layer thereon by coating a conductive polymer onto the polymer film. Further, in addition to the conductive sheet coated with the conductive polymer, the conductive solution may be applied to all sheets coated with various materials capable of providing antistatic functions, for example, surfactants, carbon black, carbon fiber, metal oxides, metal powders. It is preferable to use a sheet having an antistatic layer from use of a conductive polymer.

In the present invention, for the fabrication of the tray by cutting and forming the conductive sheet, the cut surfaces of the tray are coated with a conductive solution, whereby they can function as the conductive pathway. Thus, top and bottom surfaces of the tray, as well as the cut surfaces thereof, have electrical conductivity.

The polymer film used for the preparation of the conductive sheet of the present invention includes any polymer film usable for the fabrication of a conventional conductive sheet. The polymer film of the present invention is any one selected from the group consisting of polyester such as amorphous polyethyleneterephthalate (A-PET), polyester copolymers such as glycol modified polyethyleneterephthalate (PETG), polystyrene (PS), polystyrene copolymers, polyethylene (PE), polypropylene (PP), polycarbonate (PC), polyvinyl chloride (PVC), and mixtures thereof.

The conductive or static dissipative solution for use in the conductive sheet in addition to the conductive polymer includes a binder, a curing agent, and a solvent. As necessary, a surfactant, a lubricant, or the like may be additionally used.

The conductive polymer of the conductive solution is used in the amount of 0.05-40 wt %, and is selected from a group consisting of polypyrrole, polyaniline, polythiophene, derivatives thereof, and mixtures thereof. The derivative of the conductive polymer is selected from the group consisting of polythiophene having C₅-C₁₂ alkyl, 3,4-ethylenedioxy-substituted polythiophene, polyaniline having C₁-C₄ alkoxy, amino or sulfone, polypyrrole having C₅-C₁₂ alkyl, and mixtures thereof.

In addition, the conductive solution contains 10-40 wt % of the binder.

As such, the binder used is a water-soluble or solvent type, which is exemplified by either a low molecular weight resin having epoxy, urethane, acryl, ester, ether, styrene, amide, and imide, with a molecular weight of 500-2000, or a high molecular weight resin having epoxy, urethane, acryl, ester, ether, styrene, amide, and imide, with a molecular weight of 10,000 or more. The binder may be used along with a curing agent, such as a melamine curing agent or an epoxy curing agent.

Further, a UV-curing binder may be used. For example, there are UV-curing acrylate/methacrylate oligomers having 1-12 functional groups and UV-curing acrylate/methacrylate monomers having 1-6 functional groups. The UV-curing binder is utilized to cure the tray by irradiating it with UV ranging from 500 mJ to 1 J after the solvent is dried. Hence, the above binder is better in terms of solvent resistance and durability, but suffers from requirement of a specific UV irradiator.

The curing agent of the conductive water-soluble and solvent type solution is used in the amount of 0.1-5 wt %, and is selected from melamine, curing agent for epoxy, weak organic acids, isocyanates, and mixtures thereof. In the present invention, the curing agent is exemplified by melamine, isocyanate, tolylene diisocyanate, methylene bisphenylisocyanate, paratoluene sulfonic acid, naphthalene sulfonic acid, and mixtures thereof.

The solvent of the conductive solution should dissolve the conductive material, the binder, and the curing agent. Such a solvent is selected from the group consisting of distilled water; C₁-C₄ alcohol, methanol, ethanol, isopropanol, and n-butanol; toluene, xylene, acetone, methylethylketone, ethyleneglycol, glycerol, ethyleneglycol monomethylether, ethyleneglycolmonoethylether, ethyleneglycolmonobutylether, 1-methyl-2-pyrrolidinone, and mixtures thereof. In this case, the solvent is used in the amount of 50-80 wt %.

The conductive solution composed of the above mentioned amounts of the conductive polymer, the binder, the curing agent, and the solvent, is applied to the surface of the polymer film, thereby obtaining an antistatic layer. The use of such a conductive solution results in excellent physical properties of the antistatic layer. As such, it is desirable that the applied conductive solution includes 5-40 wt % of the conductive polymer, 10-40 wt % of the binder, 0.1-5 wt % of the curing agent and 50-70 wt % of the solvent.

Further, used to provide a desired range of point-to-ground resistance to the tray composed of the polymer sheet after forming and cutting, the conductive solution includes the conductive material, such as a conductive polymer, a carbon conductive material, metal powders, metal flakes, metal oxides, a surfactant, and mixtures thereof.

As for the conductive material, the conductive polymer is selected from a group consisting of polypyrrole, polyaniline, polythiophene, derivatives thereof, and mixtures thereof, in which the derivative of the conductive polymer is selected from among polythiophene having C₅-C₁₂ alkyl, 3,4-ethylenedioxy-substituted polythiophene, polyaniline having C₁-C₄ alkoxy, amino or sulfone, polypyrrole having C₅-C₁₂ alkyl, and mixtures thereof.

Also, carbon conductive material includes carbon black, carbon fiber, or carbon nanotube.

As for metal powders, metals having electrical conductivity are used, and examples thereof include silver or copper powders.

As for metal oxide, there is exemplified indium oxide or tin oxide.

The surfactant includes ionic surfactants, such as Staticide (ACL, USA), quaternary ammonium salts, non-ionic surfactants, or amine surfactants.

Further, the binder of the conductive solution, which is coated on the polymer film before the forming process, should not damage the antistatic layer after the forming process, so as to maintain surface resistance of the tray. Also, the binder of the conductive solution, which is applied to the cut surfaces of the tray, should have adhesion with the conductive material of the conductive solution, because the vacuum forming process is not performed after the coating of the solution to the cut surfaces of the tray. Such a binder in the conductive solution applied to the cut surfaces of the tray has either a low molecular weight resin having a molecular weight of 500-2000 with epoxy, urethane, acryl, ester, ether, styrene, amide and imide, or a high molecular weight resin having a molecular weight of 10,000 or more with epoxy, urethane, acryl, ester, ether, styrene, amide and imide.

To exhibit desired range of point-to-ground resistance of the tray by providing electrical conductivity to the cut surfaces of the tray, the use of the UV-curing binder, which is applied for providing the conductivity to the sheet per se, is essential. Since the UV-curing conductive solution has high durability against water or alcohol, it may undergo a plurality of lateral washing processes upon repeated use of the tray.

The type of the binder for the conductive solution is selected according to dispersibility of the conductive material in the solvent. As well, the binder should have high wear resistance for the use of the tray, and also, should undergo the washing process for the repeated use of the tray. Further, the binder should be high in adhesion with the polymer used for the tray.

The coating process of the conductive solution including the conductive material and the binder to the cut surfaces of the tray, accords to a known coating process. That is, the conductive material and the binder are dispersed in a proper solvent containing a water-soluble solvent, or an organic solvent, to prepare a solution or a paste type dispersion, which is then coated by use of a device to be automatically injected to the cut surfaces of the tray, or by means of manual coating.

Moreover, it is desirable in order to exhibit a desired range of point-to-ground resistance of the tray that the thickness of the conductive solution is coated onto the cut surfaces of the tray to the extent of the thickness of the antistatic layer formed on the conductive sheet of the tray, and preferably, 0.05-5 μm.

As stated above, the desired range of point-to-ground resistance can be directly provided to the tray through the coating process of a conductive solution to the cut surfaces of the tray. In addition, the desired range of point-to-ground resistance can be provided to the tray. That is, the conductive pathway between the top and bottom surfaces of the tray is formed by connecting the top and bottom surfaces of the tray with the use of an antistatic polymer product or a metal clip or clamp. Alternatively, a conductive or semi-conductive tape is separately attached to each of the top and bottom surfaces of the tray, or attached to both the top and bottom surfaces of the tray to connect the two, thus forming the conductive pathway. Therefore, the tray having the formed conductive pathway can exhibit the same antistatic properties. Further, although the attachment of the clip or the conductive, or semi-conductive, tape to only one surface of the cut tray is effective, each surface of the tray is preferably attached with such a clip or tape to prevent the clip or tape from separating from the tray upon transport and washing.

A better understanding of the present invention may be obtained through the following examples which are set forth to illustrate, but are not to be construed as the limit of the present invention.

### COMPARATIVE EXAMPLE 1

Onto a polyester sheet having a thickness of 1.2 mm, a conductive solution obtained by dissolving 5 g of poly(3,4-ethylenedioxythiophene) as a conductive polymer and 30 g of a urethane binder in 65 g of methanol was coated by a known coating process, to prepare antistatic layers being 2 μm thick on the film.

The polyester sheet having the antistatic layers thereon was formed into a tray for transporting electronic parts through a vacuum forming process and a cutting process.

Surface resistance of top and bottom surfaces of the thus obtained tray were measured according to a known method, and were found to be 10E6 Ω, respectively. Further, point-to-ground resistance crossing the top and bottom surfaces of the tray was found to be 10E12 Ω or higher, which exhibited insulation properties.

According to FTMS101C measuring a time required for dissipating a voltage of 1000 V applied to the tray to 100 V, a decay time after one charge of −1000 V was 0.1 sec, and a decay time after five continuous charges was increased to 10 sec. Upon ten continuous charges, a decay time was shown to be 1 min or more.

Therefore, it is noted that the tray obtained in the Comparative Example is unsuitable for application in trays of fine electronic parts (e.g.: HSA) requiring point-to-ground resistance less than 10E10 Ω and a decay time after continuous charge of −1000 V shorter than 2-3 sec.

### EXAMPLE 1

A conductive solution resulting from dissolving 5 g of poly(3,4-ethylenedioxythiophene) as a conductive polymer and 30 g of a urethane binder in 65 g of methanol was coated onto a polyester sheet having a thickness of 1.2 mm according to a known coating process, to obtain antistatic layers 1 and 3 being 2 μm thick on the film, as seen in FIG. 2.

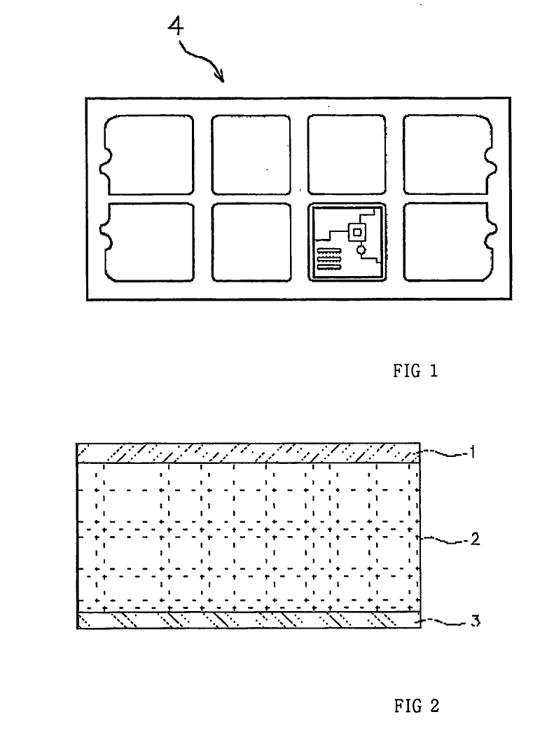

The polyester sheet having the antistatic layers thereon was subjected to vacuum forming and cutting, and thus, was formed into a tray 4 for transporting electronic parts as shown in FIG. 1.

Separately, 2.0 g of conductive carbon black (Ketjen Black, EC-300J) and 18.0 g of an acryl binder were dispersed in 80 g of toluene, to prepare a conductive solution, which then wetted a piece of cloth. Subsequently, all the cut surfaces 2 of the tray as shown in FIG. 2 were uniformly applied with the wet cloth, followed by drying at 50° C. for 5 min.

Surface resistance of the tray having the cut surfaces coated with the conductive solution was found to be about 10E6 Ω for top and bottom surfaces thereof. In addition, point-to-ground resistance crossing the top and bottom surfaces of the tray was found to be about 10E7 Ω. Also, a decay time for continuous charge of −1000 V according to FTMS101C was always measured to be 0.1 sec.

### EXAMPLE 2

A conductive solution obtained by dissolving 5 g of poly(3,4-ethylenedioxythiophene) as a conductive polymer and 30 g of a urethane binder in 65 g of methanol was coated onto a polyester sheet being 1.2 nm thick by a known coating process, to prepare antistatic layers 1 and 3 being 2 μm thick on the film, as represented in FIG. 2.

The polyester sheet having the antistatic layers thereon was subjected to vacuum forming and cutting, and thus, was formed into a tray 4 for transporting electronic parts as shown in FIG. 1.

Separately, 10 g of poly(3,4-ethylenedioxythiophene) (Baytron-P, Bayer AG, Germany) as a conductive polymer and 10.0 g of a urethane binder were dispersed in 80 g of ethylalcohol, to prepare a conductive solution, which then wetted a piece of cloth. Thereafter, all the cut surfaces 2 of the tray of FIG. 2 were uniformly applied with the wet cloth, followed by drying at 50° C. for 5 min.

Surface resistance of the tray having the cut surfaces coated with the conductive solution was found to be about 10E6Ω. Further, point-to-ground resistance crossing the top and bottom surfaces of the tray was found to be about 10E7Ω. In addition, a decay time for ten continuous charges of −1000 V according to FTMS101C was measured to be 0.1 sec.

### EXAMPLE 3

A conductive solution composed of 5 g of poly(3,4-ethylenedioxythiophene) as a conductive polymer and 30 g of a urethane binder dissolved in 65 g of methanol was coated onto a 1.2 mm thick polyester sheet according to a known coating process, to prepare 2 μm thick antistatic layers 1 and 3 on the film, as shown in FIG. 2.

The polyester sheet having the antistatic layers thereon was subjected to vacuum forming and cutting, and hence, was formed into a tray 4 for transporting electronic parts as shown in FIG. 1.

Separately, 10 g of poly(3,4-ethylenedioxythiophene) as a conductive polymer (Baytron-P, Bayer AG, Germany), 7.0 g of a hexafunctional urethane acrylate based UV-curing oligomer, 2.8 g of a monofunctional acrylate based monomer and 0.2 g of an initiator were dispersed in 50 g of ethylalcohol and 30 g of ethoxymethanol, to prepare a conductive polymer solution, whereby a piece of cloth was wetted and then uniformly applied to all the cut surfaces 2 of the tray as shown in FIG. 2. Subsequently, the tray was dried at 60° C. for 2 min and cured with the irradiation of UV of 700 mJ.

Surface resistance of the tray having the cut surfaces coated with the conductive solution was found to be about 10E6Ω. Further, point-to-ground resistance crossing the top and bottom surfaces of the tray was found to be about 10E7Ω. Also, a decay time for ten continuous charges of −1000 V according to FTMS101C was measured to be 0.1 sec.

### EXAMPLE 4

A conductive solution obtained by dissolving 5 g of poly(3,4-ethylenedioxythiophene) as a conductive polymer and 30 g of a urethane binder in 65 g of methanol was coated onto a polyester sheet having a thickness of 1.2 mm according to a known coating process, to obtain antistatic layers 1 and 3 being 2 μm thick on the film, as in FIG. 2.

The polyester sheet having the antistatic layers thereon was subjected to vacuum forming and cutting, and thus, was formed into a tray 4 for transporting electronic parts as shown in FIG. 1.

Separately, metal clips were fastened to the cut surfaces 2 of the tray as shown in FIG. 2, to form a conductive pathway between top and bottom surfaces of the tray.

Thereafter, point-to-ground resistance crossing the top and bottom surfaces of the tray was found to be about 10E7 Ω. Also, a decay time upon ten continuous charges of −1000 V according to FTMS101C was measured to be 0.1 sec.

### EXAMPLE 5

Onto a polyester sheet having a thickness of 1.2 mm, a conductive solution composed of 5 g of poly(3,4-ethylenedioxythiophene) as a conductive polymer and 30 g of a urethane binder dissolved in 65 g of methanol was coated according to a known coating process, to obtain antistatic layers 1 and 3 being 2 μm thick on the film, as in FIG. 2.

The polyester sheet having the antistatic layers thereon was subjected to vacuum forming and cutting, and thus was formed into a tray 4 for transporting electronic parts as shown in FIG. 1.

Separately, a commercially available semi-conductive tape was cut to have a diameter of 1 cm and then attached to the cut surfaces 2 of the tray so as to cross the top and bottom surfaces thereof, thus electrically connecting the top and bottom surfaces of the tray.

Thereafter, point-to-ground resistance crossing the top and bottom surfaces of the tray was found to be about 10E7 Ω. Also, a decay time upon ten continuous charges of −1000 V according to FTMS101C was measured to be 0.1 sec.

As apparent from Comparative Example and Examples, the polyester sheet having the antistatic layer thereon was subjected to vacuum forming and cutting to prepare the tray for transporting electronic parts. In the cases where the conductive solution was not applied to the cut surfaces of the tray as in Comparative Example, the surface resistance of each of the top and bottom surfaces of the tray was confirmed to be about 10E6 Ω, however, the point-to-ground resistance crossing the top and bottom surfaces of the tray was confirmed to be about 10E12 Ω or higher, which exhibited insulation characteristics. Further, upon ten continuous charges of −1000 V according to FTMS101C, the decay time was measured to be 1 min or more.

Whereas, in the present invention, the cut surfaces of the tray were coated with the conductive solution, and the top and bottom surfaces thereof were electrically connected. Thereby, the surface resistance of each of the top and bottom surfaces of the tray as well as point-to-ground resistance crossing the top and bottom surfaces thereof were confirmed to be about 10E6-10E7 Ω, which were less than 10E10 Ω. In particular, upon ten continuous charges of −1000 V according to FTMS101C, the decay time was measured to be 0.1 sec.

Consequently, the tray, which has the conductivity on the cut surfaces thereof by partially or entirely coating the conductive solution onto the cut surfaces of the tray and then drying it, or has the conductive pathway by use of the conductive tape or the antistatic or metal clip or clamp, can be applied to transport fine electronic parts requiring severe antistatic functions.

### INDUSTRIAL APPLICABILITY

As described hereinbefore, the present invention provides a method of providing a desired range of point-to-ground resistance to trays, characterized in that a conductive pathway between top and bottom surfaces of the tray results from vacuum forming and cutting of a coated polymer sheet is formed by applying a conductive solution to cut surfaces of the tray, or by use of a metal clip or clamp, an antistatic clip or clamp, or conductive tape, thus providing a desired range of point-to-ground resistance to the tray.

Therefore, the tray having a desired range of point-to-ground resistance can be used to transport fine electronic parts (e.g.: HSA, Head Stack Assembly) having severe antistatic functions.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of providing a desired range of point-to-ground resistance to trays, comprising:
coating a conductive solution onto a polymer film to obtain a conductive sheet having an antistatic layer thereon;
cutting the conductive sheet to be formed into a tray having cut surfaces; and
forming a conductive pathway on all or parts of the cut surfaces of the tray.

2. The method according to claim 1, wherein the conductive pathway is formed by coating a conductive solution to the cut surfaces of the tray.

3. The method according to claim 2, wherein the coating of the conductive solution is performed by a heat curing process or a UV-curing process.

4. The method according to claim 2, wherein the conductive solution comprises 0.05-40 wt % of a conductive material, the conductive material being selected from the group consisting of a conductive polymer, conductive carbon, a metal, metal oxide, a surfactant, and mixtures thereof.

5. The method according to claim 4, wherein the conductive polymer is selected from the group consisting of polypyrrole, polyaniline, polythiophene, derivatives thereof, and mixtures thereof.

6. The method according to claim 5, wherein the derivative of the conductive polymer is selected from the group consisting of polythiophene having C₅-C₁₂ alkyl, 3,4-ethylenedioxy-substituted polythiophene, polyaniline having C₁-C₄ alkoxy, amino or sulfone, polypyrrole having C₅-C₁₂ alkyl, and mixtures thereof.

7. The method according to claim 4, wherein the conductive carbon comprises conductive carbon black, carbon fiber, or carbon nanotube.

8. The method according to claim 4, wherein the metal comprises silver or copper.

9. The method according to claim 4, wherein the metal oxide comprises doped indium oxide or tin oxide.

10. The method according to claim 4, wherein the surfactant comprises quaternary ammonium salts, ionic surfactants, non-ionic surfactants, or amine surfactants.

11. The method according to claim 2, wherein the conductive solution is coated at a thickness of 0.05-5 μm to the cut surfaces of the tray.

12. The method according to claim 1, wherein the conductive pathway is formed by using an antistatic polymer or a metal clamp or a metal clip.

13. The method according to claim 1, wherein the conductive pathway is formed by attaching an antistatic and conductive tape to the cut surfaces of the tray.

14. (canceled)

15. A tray having a desired range of point-to-ground resistance by the method of claim 1.
